(19) United States
(12) Patent Application Publication
(10) Pub. No.: US 2016/0334549 A1
(43) Pub. Date: Nov. 17, 2016

(54) ANTISTATIC FILM AND POLARIZER ATTACHMENT DEVICE

(71) Applicants: BOE TECHNOLOGY GROUP CO., LTD., Beijing (CN); BOE (HEBEI) MOBILE DISPLAY TECHNOLOGY CO., LTD., Gu'An (CN)

(72) Inventors: Meng LI, Beijing (CN); Gang LI, Beijing (CN)

(73) Assignees: BOE TECHNOLOGY GROUP CO., LTD., Beijing (CN); BOE (HEBEI) MOBILE DISPLAY TECHNOLOGY CO., LTD., Gu'An (CN)

(21) Appl. No.: 15/130,808

(22) Filed: Apr. 15, 2016

(30) Foreign Application Priority Data
May 13, 2015 (CN) 201510243816.1

(51) Int. Cl. G02B 1/16; G02B 5/30; C09J 7/02

(52) U.S. Cl. CPC G02B 1/16; C09J 7/0275; C09J 7/0296; G02B 5/3033; C09J 2433/00; C09J 2413/00; C09J 2423/106; C09J 2201/134; C09J 2201/602; C09J 2203/318

(57) ABSTRACT

The present disclosure provides an antistatic film and a polarizer attachment device. The antistatic film includes a static electricity elimination layer configured to eliminate static charges and an adhesive layer arranged at one surface of the static electricity elimination layer. According to the present disclosure, it is able to directly attach the antistatic film onto a bearing platform of the polarizer attachment device.

### CROSS-REFERENCE TO RELATED APPLICATION

The present application claims a priority of the Chinese patent application No. 201510243816.1 filed on May 13, 2015, which is incorporated herein by reference in its entirety.

### TECHNICAL FIELD

The present disclosure relates to the field of display technology in particular to an antistatic film and a polarizer attachment device.

### BACKGROUND

In a back-end-of-line (BEOL) process for manufacturing a liquid crystal display device in the related art, it is required to attach a polarizer onto a liquid crystal display panel by a polarizer attachment device. As shown in FIG. 1, a polarizer attachment device in the related art usually includes an adsorption platform 30 onto which a polarizer is attached and a bearing platform 10 on which the display panel is arranged. During the attachment of the polarizer, the display panel 20 onto which the polarizer 40 is to be attached is arranged on the bearing platform 10, and the polarizer 40 is adsorbed onto the adsorption platform 30. Then, an attachment end of the polarizer 40 is aligned with a lateral edge of the display panel 20, and the bearing platform is moved relative to the adsorption platform, so as to attach the polarizer onto the display panel.

However, during the attachment, an electrostatic breakdown may occur for the display panel.

### SUMMARY

### (1) Technical Problem to be Solved

An object of the present disclosure is to prevent the occurrence of an electrostatic breakdown for a display panel when a polarizer is attached onto the display panel by a polarizer attachment device.

### (2) Technical Solution

In one aspect, the present disclosure provides in some embodiments an antistatic film, including a static electricity elimination layer configured to eliminate static charges and an adhesive layer arranged at one surface of the static electricity elimination layer.

Alternatively, the static electricity elimination layer is configured to eliminate the static charges through electrostatic neutralization.

Alternatively, a material of the static electricity elimination layer comprises high molecular weight polyethylene.

Alternatively, an adhesive force between the adhesive layer and the static electricity elimination layer is greater than an adhesive force between the adhesive layer and a bearing platform onto which the antistatic film is attached.

Alternatively, the adhesive layer includes a substrate, and a first adhesive and a second adhesive are coated onto two surfaces of the substrate respectively.

Alternatively, a material of the substrate comprises cotton paper, polyethylene terephthalate (PET), polyvinyl chloride (PVC), non-woven fabrics or foam, and the first adhesive and the second adhesive are each acrylic adhesive or acrylic latex.

Alternatively, a frictional coefficient between a surface of the static electricity elimination layer and a surface of a display panel which is to be subjected to a static electricity elimination is in a range from 0.1 to 1.

Alternatively, a surface hardness of the static electricity elimination layer is less than a surface hardness of the display panel which is to be subjected to the static electricity elimination.

Alternatively, a material of the first adhesive is different from a material of the second adhesive.

In another aspect, the present disclosure provides in some embodiments a polarizer attachment device, including the above-mentioned antistatic film.

Alternatively, the static electricity elimination layer is configured to eliminate static charges through electrostatic neutralization, and the polarizer attachment device further includes a detection apparatus configured to detect a resistance of a surface of the static electricity elimination layer.

Alternatively, a material of the static electricity elimination layer comprises high molecular weight polyethylene.

Alternatively, the polarizer attachment device further includes an adsorption platform onto which the antistatic film is attached.

Alternatively, an adhesive force between the adhesive layer and the static electricity elimination layer is greater than an adhesive force between the adhesive layer and the adsorption platform.

Alternatively, the adhesive layer includes a substrate, and a first adhesive and a second adhesive are coated onto two surfaces of the substrate respectively.

Alternatively, a material of the substrate comprises cotton paper, PET, PVC, non-woven fabrics or foam, and the first adhesive and the second adhesive are each acrylic adhesive or acrylic latex.

Alternatively, a material of the first adhesive is different from a material of the second adhesive.

### (3) Beneficial Effect

According to the embodiments of the present disclosure, the antistatic film may be directly attached onto the bearing platform of the polarizer attachment device, so as to enable the polarizer attachment device to be antistatic and prevent the occurrence of the antistatic breakdown for the display panel during the attachment of the polarizer, as well as to reduce the production cost cause by the replacement of the entire polarizer attachment device. The antistatic film may be applied to various devices, and thereby it is unnecessary to develop any novel antistatic device or material.

### BRIEF DESCRIPTION OF THE DRAWINGS

FIG. 1 is a schematic view showing a polarizer attachment device in the related art;

FIG. 2 is a schematic view showing an antistatic film according to some embodiments of the present disclosure;

FIG. 3 is a schematic view showing a situation where the antistatic film in FIG. 2 is attached onto a bearing platform;

FIG. 4 is a schematic view showing an adhesive layer of the antistatic film according to some embodiments of the present disclosure; and

FIG. 5 is a side view of a polarizer attachment device according to some embodiments of the present disclosure.

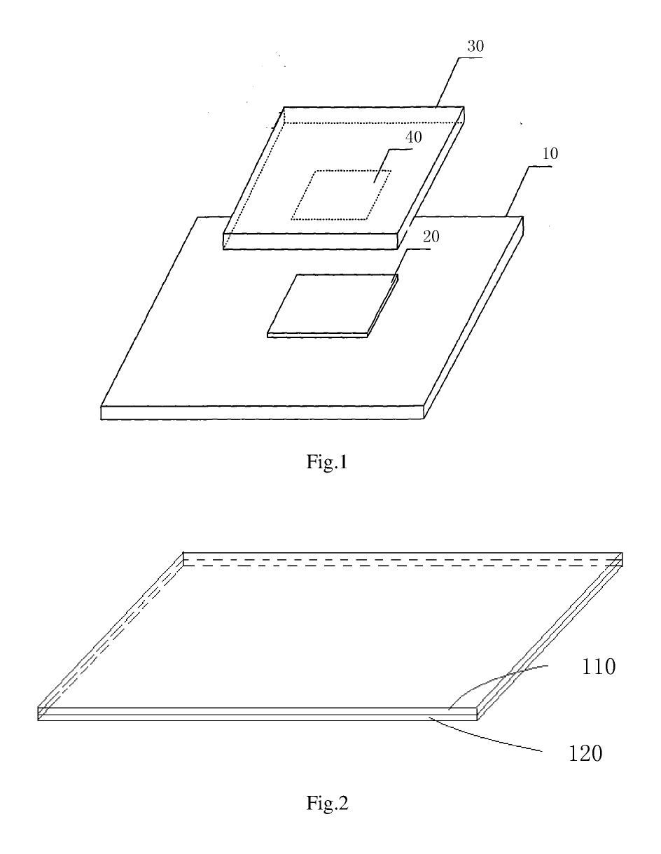

### DETAILED DESCRIPTION OF THE EMBODIMENTS

The present disclosure will be described hereinafter in conjunction with the drawings and embodiments. The following embodiments are for illustrative purposes only, but shall not be used to limit the scope of the present disclosure.

The present disclosure provides in some embodiments an antistatic film which, as shown in FIG. 2, includes a static electricity elimination layer 110 configured to eliminate static charges and an adhesive layer 120 arranged at one surface of the static electricity elimination layer 110.

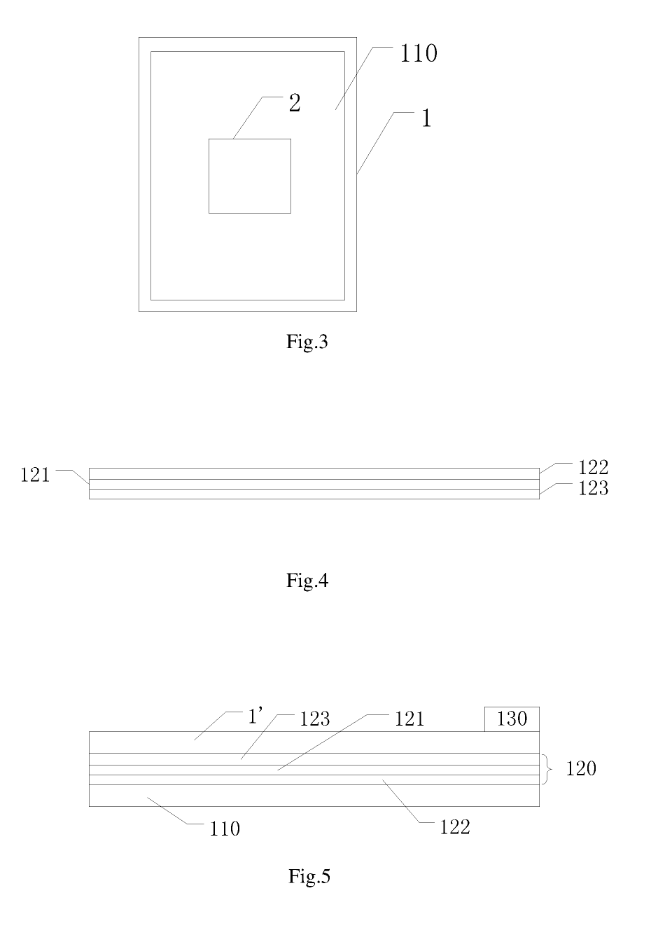

The antistatic film may be applied to a polarizer attachment device. As shown in FIG. 3, when the antistatic film is attached onto a bearing platform of the polarizer attachment device, the static electricity elimination layer 110 is attached onto a surface of the bearing platform through the adhesive layer 120. When a display panel 2 is placed onto the bearing platform 1 and comes into contact with the static electricity elimination layer 110, it is able to effectively eliminate the static charges on the display panel 2 through the static electricity elimination layer 110, thereby to prevent the occurrence of electrostatic breakdown for the display panel during the attachment of a polarizer.

According to the embodiments of the present disclosure, the antistatic film may be directly attached onto the bearing platform of the polarizer attachment device, so as to enable the polarizer attachment device to be antistatic and prevent the occurrence of the antistatic breakdown for the display panel during the attachment, as well as to reduce the production cost cause by the replacement of the polarizer attachment device. The antistatic film may be applied to various devices, and thereby it is unnecessary to develop any novel antistatic device or material.

Alternatively, the static electricity elimination layer may be configured to eliminate the static charges on the display panel through electrostatic neutralization. In this way, the static electricity elimination layer may be directly attached onto the bearing platform of the conventional polarizer attachment device, so as to eliminate the static charges without any change in the other structure of the polarizer attachment device. The resultant antistatic structure is simple and easily replaceable, so it is able to facilitate the post-maintenance of the device. To be specific, the static electricity elimination layer may be made of an appropriate material, so as to eliminate the static charges. For example, the static electricity elimination layer may be made of high molecular weight polyethylene, and have a surface with well flatness. The surface of the static electricity elimination layer may be subjected to antistatic treatment, and then attached to the adhesive layer through a roller, so as to prevent the occurrence of bubbles or folds, thereby to obtain the desired antistatic film.

Alternatively, in order to facilitate the subsequent replacement of the antistatic film, the adhesive layer of the antistatic film may be removable. When the static electricity elimination layer fails to take effect or it has reached an end of its service life, a user may directly remove the antistatic film from the bearing platform, and attach a new antistatic film thereto. In addition, in order to prevent any remaining adhesive layer during the removal, an adhesive force between the adhesive layer 120 and the static electricity elimination layer 110 is greater than an adhesive force between the adhesive layer 120 and the bearing platform 1. In this way, during the removal of the antistatic film from the bearing platform 1, it is able for the adhesive layer 120 and the static electricity elimination layer 110 to be removed from the bearing platform 1 simultaneously, thereby to prevent the attachment of the new antistatic film from being adversely affected by the remaining adhesive layer 120. For example, depending on different viscous properties of adhesives with respect to different materials, the adhesives of the adhesive layer may be appropriately selected so as to achieve the above effect.

To be specific, as shown in FIG. 4, in some embodiments of the present disclosure, the adhesive layer 120 includes a substrate 121, and a first adhesive 122 and a second adhesive 123 are coated onto two surfaces of the substrate 121 respectively. The substrate 121 may be made of cotton paper, PET, PVC, non-woven fabrics or foam, e.g., acrylic foam. The first adhesive 122 and the second adhesive 123 may each be made of a material with a stable property, e.g., acrylic adhesive or acrylic latex.

Alternatively, as shown in FIG. 3 a frictional coefficient between a surface of the static electricity elimination layer 110 and a surface of the display panel 2 is in a range from 0.1 to 1. In this way, it is able to facilitate the alignment of the display panel with the polarizer before the attachment, and prevent the slippage of the display panel during the attachment.

In addition, in order to prevent the display panel from being damaged due to uneven forces applied thereto, a surface hardness of the static electricity elimination layer 110 may be less than a surface hardness of the display panel 2. In this way, when a force is applied to the display panel 2, the static electricity elimination layer 110 may function as a buffer layer. For example, the static electricity elimination layer 110 may be made of a material having hardness less than glass.

The present disclosure further provides in some embodiments a polarizer attachment device including the above-mentioned antistatic film. The antistatic film may be directly attached onto an adsorption platform of the polarizer attachment device, so as to enable the polarizer attachment device to be antistatic and prevent the occurrence of the antistatic breakdown for the display panel during the attachment, as well as to reduce the production cost cause by the replacement of the polarizer attachment device.

In some embodiments of the present disclosure, as shown in FIG. 5, the antistatic film of the polarizer attachment device includes a static electricity elimination layer 110 configured to eliminate static charges and an adhesive layer 120 arranged at one surface of the static electricity elimination layer 110. The static electricity elimination layer 110 is attached onto an adsorption platform 1′ of the polarizer attachment device through the adhesive layer 120.

In order to facilitate the subsequent replacement of the antistatic film, the adhesive layer of the antistatic film may be removable. When the static electricity elimination layer fails to take effect or it has reached an end of its service life, the user may directly remove the antistatic film from the adsorption platform, and attach a new antistatic film thereto. In addition, in order to prevent any remaining adhesive layer during the removal, alternatively, an adhesive force between the adhesive layer 120 and the static electricity elimination layer 110 is greater than an adhesive force between the adhesive layer 120 and the adsorption platform 1′. For example, depending on different viscous properties of adhesives with respect to different materials, the adhesives of the adhesive layer may be appropriately selected so as to achieve the above effect.

Alternatively, the adhesive layer 120 includes a substrate 121, and a first adhesive 122 and a second adhesive 123 are coated onto two surfaces of the substrate 121 respectively. The first adhesive 122 and the second adhesive 123 may be made of different materials.

Alternatively, the substrate 121 may be made of cotton paper, PET, PVC, non-woven fabrics or foam. The first adhesive 122 and the second adhesive 123 may each be acrylic adhesive or acrylic latex.

Alternatively, the static electricity elimination layer is configured to eliminate static charges through electrostatic neutralization, and the polarizer attachment device further includes a detection unit 130 configured to detect a resistance of a surface of the static electricity elimination layer. Through the detection unit 130, it is able to detect the resistance of the surface of the static electricity elimination layer in real time, thereby to determine a period for replacing the antistatic film. In addition, the static electricity elimination layer may be detected by the detection unit 130 periodically, and when the resistance exceeds a predetermined range, the antistatic film may be replaced timely, so as to prevent the occurrence of the electrostatic breakdown when the antistatic film fails to take effect.

The above are merely the preferred embodiments of the present disclosure. It should be appreciated that, a person skilled in the art may make further modifications and improvements without departing from the spirit of the present disclosure, and these modifications and improvements shall also fall within the scope of the present disclosure.

What is claimed is:

1. An antistatic film, comprising a static electricity elimination layer configured to eliminate static charges and an adhesive layer arranged at one surface of the static electricity elimination layer.

2. The antistatic film according to claim 1, wherein the static electricity elimination layer is configured to eliminate the static charges through electrostatic neutralization.

3. The antistatic film according to claim 2, wherein a material of the static electricity elimination layer comprises high molecular weight polyethylene.

4. The antistatic film according to claim 1, wherein an adhesive force between the adhesive layer and the static electricity elimination layer is greater than an adhesive force between the adhesive layer and a bearing platform onto which the antistatic film is attached.

5. The antistatic film according to claim 1, wherein the adhesive layer comprises a substrate, and a first adhesive and a second adhesive are coated onto two surfaces of the substrate respectively.

6. The antistatic film according to claim 5, wherein a material of the substrate comprises cotton paper, polyethylene terephthalate (PET), polyvinyl chloride (PVC), non-woven fabrics or foam, and the first adhesive and the second adhesive are each acrylic adhesive or acrylic latex.

7. The antistatic film according to claim 1, wherein a frictional coefficient between a surface of the static electricity elimination layer and a surface of a display panel which is to be subjected to a static electricity elimination is in a range from 0.1 to 1.

8. The antistatic film according to claim 1, wherein a surface hardness of the static electricity elimination layer is less than a surface hardness of the display panel which is to be subjected to the static electricity elimination.

9. The antistatic film according to claim 5, wherein a material of the first adhesive is different from a material of the second adhesive.

10. A polarizer attachment device, comprising the antistatic film according to claim 1.

11. The polarizer attachment device according to claim 10, wherein the static electricity elimination layer is configured to eliminate static charges through electrostatic neutralization, and the polarizer attachment device further comprises a detection apparatus configured to detect a resistance of a surface of the static electricity elimination layer.

12. The polarizer attachment device according to claim 11, wherein a material of the static electricity elimination layer comprises high molecular weight polyethylene.

13. The polarizer attachment device according to claim 10, further comprising an adsorption platform onto which the antistatic film is attached.

14. The polarizer attachment device according to claim 13, wherein an adhesive force between the adhesive layer and the static electricity elimination layer is greater than an adhesive force between the adhesive layer and the adsorption platform.

15. The polarizer attachment device according to claim 10, wherein the adhesive layer comprises a substrate, and a first adhesive and a second adhesive are coated onto two surfaces of the substrate respectively.

16. The polarizer attachment device according to claim 15, wherein a material of the substrate comprises cotton paper, polyethylene terephthalate (PET), polyvinyl chloride (PVC), non-woven fabrics or foam, and the first adhesive and the second adhesive are each acrylic adhesive or acrylic latex.

17. The polarizer attachment device according to claim 15, wherein a material of the first adhesive is different from a material of the second adhesive.
